(19) United States
(12) Patent Application Publication
(10) Pub. No.: US 2024/0334019 A1
(43) Pub. Date: Oct. 3, 2024

(54) SYSTEMS AND METHODS FOR ENABLING SEAMLESS CROSS-PLATFORM RECORDING AND PLAYBACK OF CONTENT

(71) Applicant: Adeia Guides Inc., San Jose, CA (US)

(72) Inventors: Dhananjay Lal, Englewood, CO (US); Reda Harb, Issaquah, WA (US); Christopher Phillips, Hartwell, GA (US)

(21) Appl. No.: 18/127,470

(22) Filed: Mar. 28, 2023

(51) Int. Cl. H04N 21/482; H04N 21/262; H04N 21/2662; H04N 21/6587

(52) U.S. Cl. CPC H04N 21/4825; H04N 21/26258; H04N 21/2662; H04N 21/6587

(57) ABSTRACT

A first plurality of content items available from a first content service is identified, and a second plurality of content items not available from the first content service but related to the first plurality of content items is also identified. An order in which to play back content items from both the first plurality of content items and the second plurality of content items is determined. A first content item from the first plurality of content items is then played back. Based on the order, a second content item from the second plurality of content items is identified for playback next and is automatically played back from the second content service. At the conclusion of the entire order of content item, the user may be returned to a user interface of the first content service or the content service from which playback of content items was initiated.

### BACKGROUND

This disclosure is directed to recording and playback of content items from multiple service platforms. In particular, techniques are disclosed for initiating and/or scheduling, from a first content platform, recordings of content items available from a second content platform. Techniques are further disclosed for enabling seamless playback of an ordered set of content items wherein different content items are available from, or recorded on, different content platforms and/or recording services.

### SUMMARY

The video industry is in a state of flux. Over-the-Top services (OTTs) are on the rise, while traditional linear TV offered by cable or satellite providers is on the decline. Connected TVs (CTVs) or Smart TVs that enable video streaming content are also gaining adoption, driven by OTT adoption. Cable providers are also jumping into the CTV market. OTT and traditional content distributors and producers are trialing “skinny bundles” to give customers greater choice. To capture user awareness, Free Ad-supported Streaming TV channels (FAST) are also being trialed, such as Xumo, Tubi, Peacock, The Roku Channel, IMDBTV, and Samsung TV+ etc. OTT stalwarts such as Netflix are introducing lower priced ad-supported subscriptions to skim greater revenue. Further, content distributors such as cable providers are vying to be the aggregators of all content for subscribers, OTT and linear TV, via their Set-top box (STB) platforms.

Many households subscribe to both traditional linear TV and OTT content. However, the integration and crossover between the services is limited. Popular video content is recycled across both linear broadcasting as well as OTT. However, if a user watches a show in an OTT app, their ability to harvest missing or future content of the same show using linear TV does not exist. This disclosure addresses how a subscriber that watches a show on an OTT app may leverage the ability to record relevant episodes or series of that show from linear TV service using their digital video recorder (DVR) service or personal video recorder (PVR) service.

DVR deployment strategies, especially Cloud DVR (cDVR) strategies, have been influenced by a few factors including regional copyright laws and specific legal restrictions in different geographies. While the “private copy” model in the US requires service providers to handle scale and performance in recording, the legal climate in Europe gives telecoms and cable service providers a unique opportunity to offer Cloud DVR services based on shared copy models.

Blended TV, a term used for consolidation of linear TV and streaming TV options within one subscription and platform, is not new. For example, Comcast and Sky already offer customers the opportunity to download their Netflix app on their STBs, and even integrate payment for Netflix within their cable bill. This is, however, a very loose integration, where both parties' apps operate independently, though an account linking occurs which enables Comcast to bill the customer for their Netflix subscription. The content offered by each provider remains siloed, and each app contacts its own cloud infrastructure for delivery.

Connected TV providers have also attempted to connect linear TV and streaming TV services, to differentiate their platforms with user-friendly features. One such feature is “Jump View” or “Jump Ads” from Vizio. With this feature enabled, a banner pops up at the end of a show and the viewer is prompted to go to the network's app on their Vizio TV to watch other available episodes of the show they've just watched on linear. This gives viewers a seamless way to jump back and forth between linear and streaming and to take advantage of the network's streaming app in much the same way they might take advantage of MVPD VOD. The technology is straightforward as well, and Vizio uses its Inscape ACR technology to identify the show the viewer is watching. If the show is part of the Jump View program, a banner will be displayed at the end of the show asking the viewer(s) if they want to watch more episodes and they will seamlessly be taken to the streaming app. A similar feature is also being tested by FOX in its comedy “Welcome to Flatch.” “Jump Ads” provides a bridge from linear TV to a streaming app, but not vice versa.

Authorization protocols, such as OAuth 2.0 are key to enabling the connectivity required by this disclosure between various OTT, linear, and recording services. OAuth (Open Authorization) 2.0 is the de facto industry standard for online authorization. OAuth 2.0 provides access to resources such as remote APIs, microservices, data etc. As will be discussed later, in the present disclosure, the client app is an OTT app or a Connected TV OS, that requests scheduled DVR resources from a different provider. In some embodiments, this provider of recording services is also the linear TV provider. It is worth noting, that live OTT streaming apps may also have their own DVR service. Some providers present some live OTT apps with their proprietary DVR implementations and allow users to avail themselves of their recording capabilities. However, these apps can only schedule recordings based on what is available in their own catalog, similar to how linear TV DVR implementations work. In this disclosure, the OTT app “crosses over” to find information from the customer's linear TV broadcasting service and uses this information to schedule recordings with the customer's linear TV recording service.

Finally, to enable this invention, the recording service provider that is integrated with the linear TV service, has API resources that may be accessed by another service provider such as an OTT app or a connected TV OS/app (via an authorization protocol). To encourage vendor solutions built on standardized platforms, broadband and Pay TV service providers have come together in defining the RDK (Reference Design Kit) software platform. Reference Design Kit is a fully modular, portable, and customizable open-source software solution that standardizes core functions used in video, broadband and IoT devices. Further, RDK-V (Reference Design Kit for video) is an open-source software platform for set-top boxes, smart media devices and video services. Diving further into RDK-V, RDK-V IP provides a common method to manage video playback functions. The IP client device serves as an interface and receives video content from an in-home media gateway device or from an external media server. On the other hand, RDK-V Hybrid provides a common method to manage complex video functions such as tuning, conditional access, DRM, and stream management, including recording. For cloud recording (such as a Cloud DVR), a service provider may configure its own video CDN or use another CDN solution for recording, leveraging the platform APIs developed for writing video streams to the cloud.

A user that watches a show in an OTT app, permits the OTT app or the CTV OS/app to search and record relevant content (e.g., other episodes or seasons of the same show, sequels, prequels, etc.) from their linear TV service. The OTT/CTV app retrieves electronic program guide (EPG) schedule for the linear TV (broadcast service), performs a search for relevant content in the schedule, presents the results to the user, and on their behest requests their recording service (DVR device or Cloud DVR) to schedule the recording(s).

First, a determination of the content being watched by the user is made. For an OTT service, this is trivial as it is serving this content to the user, typically from a cloud CDN. A CTV OS can determine the watched content using Automatic Content Recognition (ACR). Audio-based ACR or visual-based ACR may be deployed by the CTV OS. ACR performs pattern-matching to a reference library of catalogued content. An audio or visual signal is captured from the CTV and cross-referenced with the library of audio and visual signals from shows, movies and ads to find the match.

Once the content is determined, an API request is made to a provider for obtaining the programming schedule of the linear TV service that the user is subscribed to. This typically provides a 2-3 week lookahead into what shall air on the linear TV service in the user's home location. This requires that the OTT app or CTV OS is aware of the user's linear TV service. In some embodiments the OTT app, if installed on a linear TV service provider's STB, is aware of the user's linear TV service provider derived from the installed app version (though it may not be aware of the user's video subscription package). Similarly, a CTV OS can determine this based on the installed linear TV apps on the CTV. In another approach, the CTV OS may use ACR to profile the content played in a linear TV app to determine the likely user subscription package. In another embodiment, account linking is used to precisely determine the linear TV service provider and the user's subscription package. This may involve an API that is used by the OTT app or CTV OS to determine the user's linear TV subscription package. OAuth 2.0 or a similar protocol can be used to enable this, and the user may enter their linear TV subscription login into their OTT app. As previously explained, OAuth 2.0 is an authorization protocol, and enables a linear TV server to provide subscription package information about the user without sharing credentials between the OTT and linear TV platforms.

Various providers can be used to provide broadcasting schedules in machine readable formats such as XML, JSON, CSV etc. For example, Schedules Direct provides a low-cost TV program listing service for open source and freeware digital video recorders. Similarly, TitanTV is a free online TV Guide service that uses geolocation technology to provide accurate over-the-air, cable, and satellite channel lineups for the user's region. TV Listings aggregates Canadian television schedule information from many sources and makes it available under a common API. In some embodiments, the linear TV service provider API is used to receive the broadcasting schedule.

Next, content relevant to the first watched content on the OTT app is searched within the linear TV programming schedule. Relevant content may be missing episodes, future episodes of the show that the user is watching in the OTT app, sequels, prequels, etc. The relevant content may be derived by using unique content identifiers such as Gracenote ID and associated metadata for performing the search. The search results are presented to the user by the OTT app, and the user makes a selection of the relevant linear TV content that they may want to record using their recording service (DVR/PVR/cDVR etc.).

Subsequently, the OTT app seeks an authorization via OAuth 2.0 (or similar) to the recording service for recording the chosen content item(s) at the scheduled time(s). The recording service validates the scope of the request, i.e., whether the user is authorized to access the content item(s) and the recording service itself. In order to validate the user's content access rights, the recording service may query the linear TV service. Again OAuth 2.0 may be used by the recording service to perform this action, or a proprietary protocol may be used (if recording service and linear TV service are from the same service provider within the same user account). After receiving confirmation from the recording service, the OTT app presents this to the user. The app may refer the user to their recording service's user interface for further information.

In the above description, the OTT app or the CTV OS is used to describe not only the app or the OS, but also the back-end services associated with the provider. For example, the provider's cloud infrastructure may be used to retrieve the linear broadcast schedule, perform search and discovery of the relevant content, as well as contact the recording service for scheduling the recording. The recording service itself may be device based within the home (such as a DVR or PVR device), or it may perform the recording to a cloud location (Cloud DVR). The method described does not depend on this property.

Further, the method described herein, that requests the recording of a show/episode from linear TV does not depend on the communication stack and MAC/PHY/NWK implementation of the linear TV service. The linear TV service may be implemented using QAM (Quadrature Amplitude Modulation) over a traditional cable plant, or over satellite communication technology or even a live linear broadcast delivered as IP video using multicast ABR streaming.

In one embodiment, subscribers of the DVR service can allocate storage capacity to recordings requested by third party apps. For example, a Pay TV subscriber whose cDVR package includes 200 recording hours, can allocate 25% of such capacity to recordings requested by OTT apps such as Netflix. Similarly, subscribers with local in-home DVR(s) can designate one of the DVRs as an “OTT DVR” or even a portion of the in-home DVR storage capacity to recordings from external OTT apps. Additionally, capacity can be allocated on a per-profile basis (profiles associated with the OTT account).

In another embodiment, an OTT service might determine a user's interest in a show based on the user's viewing history of the show (e.g., determine binge watching behavior, positive rating, etc.), and present a single recording option to the user such as “Record Missing Episodes.” This frees the user from figuring out which episodes are not available on the OTT service but may be recorded using the user's Pay TV service.

Similarly, the OTT service might record episode(s) that are available today in its catalogue but anticipates that such episode(s) will not be available to the user in the future, based on the user's binge-watching patterns of the show and last availability date of the episode(s). This can also be presented as an option to the user, such as “Record Backup episodes.”

In one embodiment the recording request generated by the OTT Scheduler service includes episode or content IDs that are not part of the existing Pay TV provider's EPG. Such request is known as a “Wishlist” request and fulfilled by the DVR service if/when such content items become available. For example, the OTT scheduler can automatically subscribe the user to recording a next season of the show if it is determined that the OTT service won't have rights to stream such season when it airs for the first time on a TV channel.

The OTT scheduler also includes a conflict resolution module that can resolve conflicts automatically or query the user to take an action. For example, a DVR service might reject an external recording request if the allocated storage capacity has been reached or if recording such content could result in exceeding the allocated capacity or if the storage capacity is within a threshold of being reached (e.g., 5% remaining). However, such conflict can be resolved in a number of ways. For example, recorded/watched content items (requested by the OTT scheduler) can be deleted, storage capacity can be increased (allocation is changed), existing schedule recording(s) can be cancelled (based on show priorities indicated by the user or user's watch history), or temp allocation of extra storage if the DVR service doesn't have pending “native” recording requests. In some embodiments, a lower bitrate/quality can automatically be chosen for recording when storage is low, based on calculation of estimated storage required for different bitrates. Duplicate requests are ignored. For example, the content ID might have already been scheduled for recording (by another profile).

In one embodiment, the DVR recording service monitors and manages storage to ensure sufficient space for recording. An episode is subject to, or scheduled for, recording since it is not available on the OTT, but it may become available on the OTT after the DVR recording. The DVR service can be configured to eliminate duplicates as the user desires. Duplicates can be removed either before or after watching.

Another feature contemplated herein is seamless next episode playback from multiple sources. The OTT app is aware of which content items were successfully recorded by the DVR service based on periodic updates from the DVR service. For example, the DVR service might issue a POST request after it has successfully recorded a content item requested by the OTT scheduler. Similarly, the OTT scheduler is aware of pending recording requests for the various content items. Such metadata is available to be dynamically presented with the OTT service. For example, such metadata can be presented on the show's page where all the episodes are shown along with their source (OTT or DVR). The DVR's service playback API provides links or URLs (deep links) to enable the user to play the recorded content. This includes auto playing of the next episode/switching from OTT to DVR playback. In one embodiment, a preview of the recorded content is played within the OTT application. For example, the preview can be the preview as advertised on the broadcasting channel. Additionally, previews can be generated using known techniques (editorial or automatic) and shared with the OTT service to be presenting it. It is important to know that a preview can be as short as 2 seconds or few frames played in series.

In one embodiment, the playback from multiple sources may consider the quality of content to ensure the best user experience. When OTT streaming is having bandwidth issues, the DVR recorded linear content, when locally stored or higher bandwidth available for better quality, may be chosen from multiple available versions.

In another embodiment, if the user is consuming an episode on the OTT service, and the next episode to be played is a recorded episode from the DVR service, the OTT service or playback API might issue an intent-to-play-request to the DVR playback service to initialize playback (e.g., pre-buffer a portion of the content) for a near seamless transition between the two services. Such request or series of communications can be done in the device. For example, the app associated with the DVR service is invoked locally. In other cases, the OTT service may be linked to the DVR service.

Content items recorded by the DVR service can be presented within the OTT app on other forms. For example, the OTT app can present a dedicated row labeled “Recorded for Reda” on the OTT home page or Reda's profile page.

Systems and methods are described herein for enabling cross-service content recording. A first content item consumed from a first content service is identified. A second content item related to the first content item that is not available from the first content service is then subsequently identified. For example, a user may be watching episodes of a TV show on a first content service (e.g., Netflix) and some episodes of the TV show may not be available on that platform. In some cases, the first content service offers on-demand access to old episodes of the TV show while a new season of the TV show are aired weekly on another content service such as a Cable TV channel. Programming schedule data from a second content service is retrieved and used to determine whether the second content item is scheduled to be available from the second content service. If so, recording of the second content item from the second content service is scheduled and confirmation that recording of the second content item from the second content service has been scheduled is generated for output to the user.

In some embodiments, the first content service may request authorization from the second content service to access the second content item and the scheduled time. The recording may be performed by the first content service, the second content service, or a separate recording service such as a cloud DVR or a local DVR. The first content service may therefore also request authorization for allocation of recording resources at the scheduled time. In response to receiving the authorization from the recording service, an instruction may then be sent to the recording service to schedule the recording of the second content item.

In some embodiments, a user interface element linked to the recording service may be generated for display in a user interface of the first content service, wherein selection of the user interface element causes output of a user interface of the recording service. An identifier of the second content item may also be generated for output. Selection of the identifier may then cause scheduling of a recording of the second content item. An indication that the second content item has been recorded, or that the second content item is scheduled for recording, may also be generated for output. Selection of an indication that the second content item has been recorded may cause playback of the second content item from the recording service. When playback ends, either due to completion of the content item or a command received from a user input device, the user is returned to a user interface of the first content service.

Also described herein are systems and methods for seamless playback of content items from different content services. A first plurality of content items available from a first content service is identified, and a second plurality of content items not available from the first content service but related to the first plurality of content items is also identified. For example, some episodes of a TV show may be available from the first content service while other episodes are not. If it is determined that content items of the second plurality of content items are available from a second content service, those content items may also be played back along with the first plurality of content items. An order in which to play back content items from both the first plurality of content items and the second plurality of content items is determined. For example, episodes of a TV show may be arranged in release order. A first content item from the first plurality of content items is then played back. Upon detecting an end of playback of the first content item from the first plurality of content items, the order is used to identify that a second content item from the second plurality of content items is to be played back next. The second content item is then automatically played back from the second content service. If, at the conclusion of the second content item, the order indicates that a third content item is next to be played back from the first content service, the third content item is automatically played back from the first content service. At the conclusion of the entire order of content item, the user may be returned to a user interface of the first content service or the content service from which playback of content items was initiated.

If content items in the order are not available from either the first or second contents services, playback of those content items may not be possible. Upon detecting an end of playback of a content item, the next content item in the order is identified and it is determined whether the next content item is available from one of the content services. If it is not available, playback of content items is paused, and a notification is generated for output indicating that the next content item is not available. In some embodiments, availability of subsequent content items following the next content item is also determined. If a subsequent content item in the order is available, a prompt is generated for output asking the user if they would like to resume playback of content items in the order beginning with the next available content item. In response to a selection of the prompt, the next available content item is identified and the content service from which it is available is determined. Playback from that content service of the next available content item then begins automatically.

In some cases, the next content item may be available from a third content service to which the user is not currently subscribed. A prompt may then be generated for output comprising an option to subscribe to the third content service. Alternatively, the prompt may comprise an option to purchase temporary access to next content item from the third content service without requiring a full subscription to the third content service.

Sometimes the next content item in the order may be available from multiple content services. A respective quality level associated with the content item available from each content service is determined. This may be based on network conditions between the playback device and a server of the content service and/or media characteristics of a copy of the content item available from the content server. The content service having the highest quality level associated with the content item is then selected and playback of the content item from the selected content service begins automatically.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an example of a user interface of a content service from which recording of content items from other services can be instructed, in accordance with some embodiments of the disclosure;

FIG. 2 is a sequence diagram showing instruction from a first content service to, and scheduling of a recording of a content item from, a second content service, in accordance with some embodiments of the disclosure;

FIG. 3 shows an example of a user interface of a content service indicating that some content items not available from the content service have been or are scheduled to be recorded on a DVR, in accordance with some embodiments of the disclosure;

FIG. 4 shows an example of a user interface dialog from which automatic playback of content items from multiple services can be enabled, in accordance with some embodiments of the disclosure;

FIG. 5 is a bock diagram showing component and data flow therebetween of a user equipment device from which seamless recording and playback of content items from multiple services may be performed, in accordance with some embodiments of the disclosure;

FIG. 6 is a flowchart representing an illustrative process for enabling cross-service content recording, in accordance with some embodiments of the disclosure;

FIG. 7 is a flowchart representing an illustrative process for setting up a recording of a content item scheduled to be available from another content service, in accordance with some embodiments of the disclosure;

FIG. 8 is a flowchart representing an illustrative process for playing back, from a user interface of a first content service, a content item from a second content service, in accordance with some embodiments of the disclosure;

FIG. 9 is a flowchart representing an illustrative process for offering a subscription to a content service on which a content item is or will be available, in accordance with some embodiments of the disclosure;

FIG. 10 is a flowchart representing an illustrative process for seamless playback of content items from different content services, in accordance with some embodiments of the disclosure;

FIG. 11 is a flowchart representing an illustrative process for playing back a set of content items from different content services, in accordance with some embodiments of the disclosure; and

FIG. 12 is a flowchart representing an illustrative process for selecting a content service from which to play back a next content item, in accordance with some embodiments of the disclosure.

### DETAILED DESCRIPTION

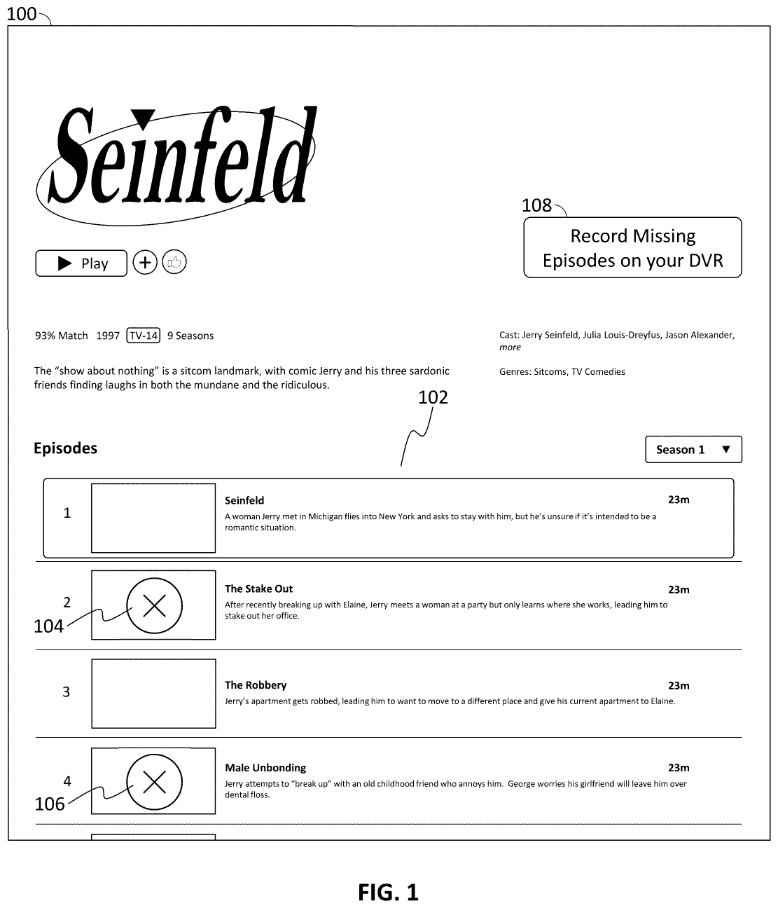

FIG. 1 shows an example of a user interface 100 of a content service from which recording of content items from other services can be instructed, in accordance with some embodiments of the disclosure. User interface 100 may display a listing of episodes 102 associated with a TV show, such as Seinfeld. While a complete episode listing may be presented, some episodes may not be available from the content service. This may be indicated to the user visually by the presence of an indicator, such as indicators 104 and 106, displayed in association with each respective missing episode. Other types of indications, such as graying out, may also be used. Other content services may provide access to the missing episodes. For example, a cable TV service to which the user subscribes may include a channel on which episodes of Seinfeld are scheduled to be played. User interface 100 may present option 108 to record missing episodes on the user's DVR from the cable TV service. It should be noted that, as referred to herein, a DVR may be a local DVR or a cloud-based DVR service. A local DVR may be located within the premises associated with the user's subscription and may be a separate piece of equipment or may be integrated into one or more user equipment devices, such as set-top boxes. In response to selection of option 108, the content service may communicate with the cable TV service and/or the DVR service (whether local or cloud-based) to schedule recording of the missing episodes.

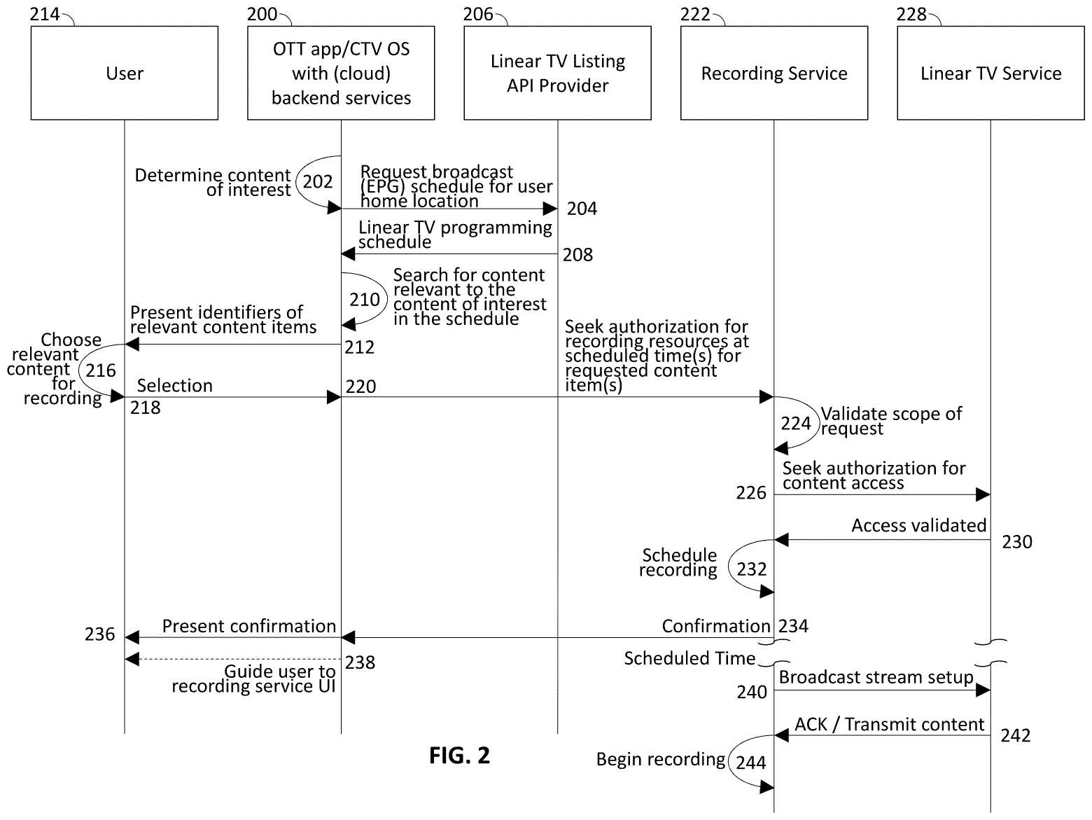

FIG. 2 is a sequence diagram showing instruction from a first content service to, and scheduling of a recording of a content item from, a second content service, in accordance with some embodiments of the disclosure. An OTT provider application (“app”) or CTV operating system 200 may, at 202, determine content of interest to the user. This may be accomplished by, for example, identifying a content item that is currently being consumed or that was recently consumed by the user, or by identifying content selected by the user from among a plurality of search results. At 204, the OTT app or CTV OS transmits a request for electronic program guide data or other broadcasting schedule data for the user's home location to linear TV listing API provider 206. The request may include an identifier of the content of interest, an identifier of a specific linear TV service to which the user subscribes, or any other relevant data. At 208, linear TV listing API provider 206 transmits the requested data to OTT app or CTV OS 200.

At 210, OTT app or CVT OS 200 searches for content relevant to content of interest in the received schedule data. If relevant content is found, such as an episode of a TV show that is not available from OTT app 200, OTT app 200 presents, at 212, identifiers of relevant content items to user 214. User 214 may then, at 216, choose relevant content items for recording. The user's selection is received, at 218, by OTT app or CTV OS 200. In response to receiving the selection, OTT app or CTV OS 200 transmits, at 220, to recording service 222, a request for authorization for recording resources at the scheduled times for the requested content items. At 224, recording service 222 validates the scope of the request and, at 226, seeks its own authorization for content access from linear TV service 228.

At 230, recording service 222 received an access validation message from linear TV service 228 and, at 232, schedules recording of the requested content items. Then, at 234, recording service 222 transmits a confirmation that recording has been scheduled to OTT app or CTV OS 200, which is then presented, at 236, to the user. In some embodiments, OTT app or CTV OS 200 may also, at 238, guide the user to a user interface of recording service 222. When a scheduled recording time is reached, at 240, recording service 222 sets up a broadcast stream by transmitting a request to linear TV service 228 for the content item to be recorded. The request may include an identifier of the content item, a channel (virtual or physical) on which the content item is to be broadcast, or any other information. At 242, recording service 222 receives an acknowledgement from linear TV service 228 and linear TV service 228 transmits the content to recording service 222. At 244, recording service 222 begins recording the incoming content from linear TV service 228.

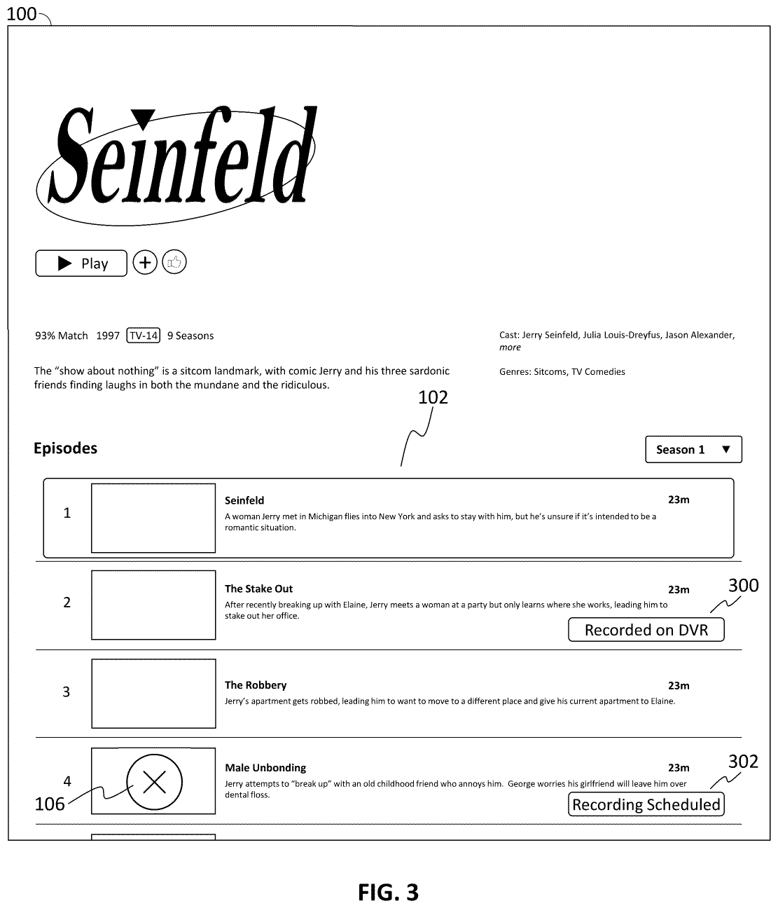

FIG. 3 shows an example of a user interface of a content service indicating that some content items not available from the content service have been or are schedule to be recorded on a DVR, in accordance with some embodiments of the disclosure. User interface 100 may display listing of episodes 102. As shown in FIG. 1, episodes 2 and 4 of Seinfeld were indicated to be unavailable from the content service associated with user interface 100. Having received selection of an option to record missing episodes, episodes 2 and 4 may have been scheduled for recording on a DVR or other recording service. In the example of FIG. 3, the scheduled time for episode 2 has passed and user interface 100 displayed an indication 300 indicating that episode 2 has been recorded on the user's DVR or other recording service. As the scheduled time for episode 4 has not yet passed, user interface 100 continues to display indication 106 that episode 4 is not available. User interface 100 also displays indication 302 that episode 4 is scheduled for recording.

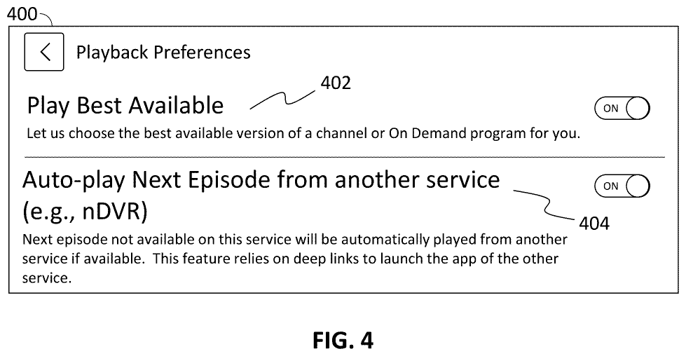

FIG. 4 shows an example of a user interface dialog 400 from which automatic playback of content items from multiple services can be enabled, in accordance with some embodiments of the disclosure. Dialog 400 provides the user with options relating to playback preferences. Several options may be presented to the user. One option is a “play best available” option 402. When activated, this option allows the content service to determine the best available version of a content item and playback the content item from the content service providing the best available version. For example, a content item may be available from two OTT services and a linear TV service, and be recorded on a DVR. The content service may compare each version. This may include comparison of network conditions between the user and a server of each OTT service, a resolution of each available version, or other comparisons. Playback of the best version of a selected content item from the associated content service can then be performed from within a user interface of a single content service. Another option is an “auto-play next episode from another service” option 404. When enabled, this option allows the content service to play back multiple content items in a playlist or episode list, even when some of the content items are available from different content services.

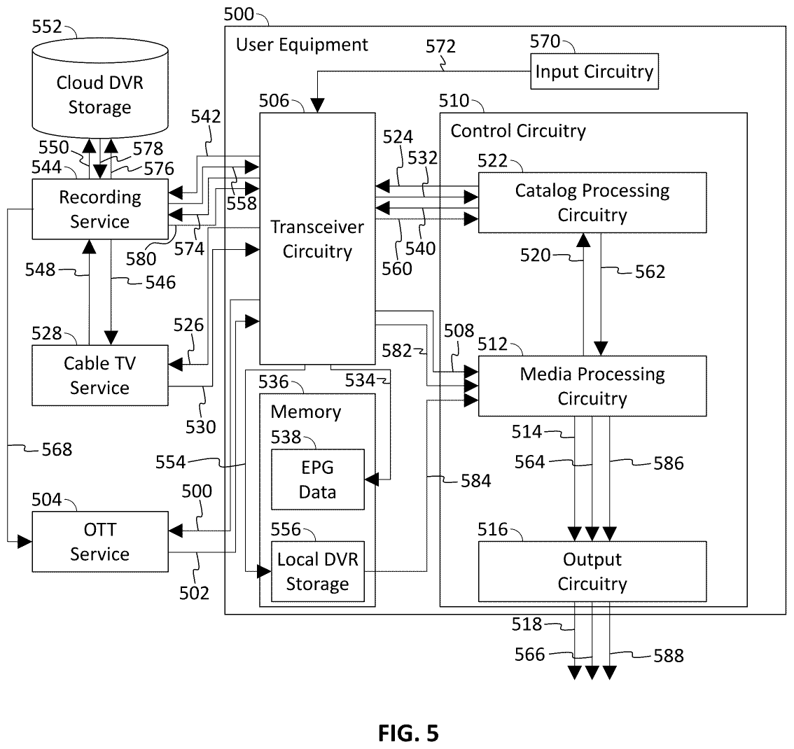

FIG. 5 is a bock diagram showing component and data flow therebetween of a user equipment device from which seamless recording and playback of content items from multiple services may be performed, in accordance with some embodiments of the disclosure. User equipment 500 receives 502 a content item from OTT service 504. User equipment 500 receives the content item using transceiver circuitry 506. Transceiver circuitry 506 may comprise a network connection over which data can be transmitted to and received from remote devices, such as an Ethernet connection, Wi-Fi connection, mobile broadband interface, or connection employing any other suitable network protocol. Transceiver circuitry 506 may also include a cable television tuner or other connection suitable for receiving broadcast media and VOD content from a cable headend. Transceiver circuitry 506 transmits 508 the content to control circuitry 510, where it is received at media processing circuitry 512. Control circuitry 510 may be based on any suitable processing circuitry and comprises control circuitry and memory circuitry, which may be disposed on a single integrated circuit or may be discrete components. As referred to herein, processing circuitry should be understood to mean circuitry based on one or more microprocessors, microcontrollers, digital signal processors, programmable logic devices, filed-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Media processing circuitry 512 processes the media stream for output to a user device. For example, media processing circuitry 512 may decode audio and/or video data from the media stream and reencode it into a format suitable for streaming. Media processing circuitry 512 then transmits 514 the media stream to output circuitry 516, which then outputs 518 the content item for consumption by a user. This may include driving a video display and/or speaker. Media processing circuitry 512 may also extract an identifier of the content item being received from OTT service 504. For example, media processing circuitry 512 may access metadata contained within one or more frames or packets of the content item or metadata received separately from OTT service 504 associated with the content item. Media processing circuitry 512 then transmits 520 the identifier of the content items to catalog processing circuitry 522.

Catalog processing circuitry 522 transmits 524 a request for a listing of content items associated with the content item received from OTT service 504 to transceiver circuitry 506, which in turn transmits 526 the request to cable TV service 528. In response, cable TV service 528 transmits 530 scheduling data (e.g., EPG data) for at least a set of channels to which the user has access to user equipment 500, where it is received using transceiver circuitry 506. For example, an account associated with the user may be accessed to determine which channels the user has access to based on their subscription package. Transceiver circuitry 506 then transmits 532 the scheduling data to catalog processing circuitry 522. Transceiver circuitry 506 may also transmit 534 the scheduling data to memory 536 for storage in memory area 538, which may be a dedicated area of memory 536 for scheduling data. Memory 536 may be any suitable electronic storage device such as random-access memory, read-only memory, hard drives, optical drives, solid state devices, quantum storage devices, or any other suitable fixed or removable storage devices, and/or any combination of the same. Storage of the scheduling data in memory 536 may reduce the need to retrieve such data if the user selects a different, unrelated content item for playback from OTT service 504. In some embodiments, prior to or during transmission of the content item from OTT service 504, OTT service 504 also transmits a listing of content items related to the content item and an indication of whether each content item is available from OTT service 504.

Catalog processing circuitry 522 compares the listing of content items related to the content item available from OTT service 504 with the scheduling data received from cable TV service 528 to determine if any content items not available from OTT service provider 504 are scheduled to be available from at least one channel or on-demand resource provided by cable TV service 528. If a content item not available from OTT service provider 504 is determined to be scheduled to be available from cable TV service 528, catalog processing circuitry 522 transmits 540 an instruction to record that content item to transceiver circuitry 506, which in turn transmits 542 the instruction to recording service 544. Recording service 544 may be a cloud-based DVR (cDVR) service, a network-based DVR (nDVR) service, or a local DVR service.

Upon receiving the instruction, recording service 544 transmits 546 a request for authorization to access the content item at the scheduled time to cable TV service 528. Cable TV service 528, after confirming that the user will have access to the content item, based on their subscription status, at the scheduled time, transmits 548 a confirmation to recording service 544. When the scheduled time arrives, recording service 544 may request or receive the content item from cable TV service 528. Recording service 544 then transmits 550 media data of the content item to cloud DVR storage 552. In embodiments where a local DVR is used and is integrated into user equipment 500, recording service 544 may transmit the media data of the content item to user equipment 500, whether transceiver circuitry 506 transmits 554 the media data to memory 536 for storage in local DVR storage 556.

When a recording has been successfully scheduled, or when a recording has been successfully completed, recording service 544 transmits 558 an indication that the successful recording or scheduled recording to user equipment 500 where it is received using transceiver circuitry 506. Transceiver circuitry 506 then transmits 560 the indication to catalog processing circuitry 522. When processing the listing of content items from OTT service 504, catalog processing circuitry 522 identifies content items that have been or are scheduled to be recorded and transmits 562 indications of those recording or scheduled recordings to media processing circuitry 512 which in turn transmits 564 a visual indicator to output circuitry 516 to be output 566 to the user with the listing of content items. In some embodiments, recording service 544 transmits 568 the indication to OTT service 504. OTT service 504 may then include indications of recorded items or items scheduled to be recorded when transmitting content listings to user equipment 500.

The user may select an indication of a recorded content item to play back the recorded copy of that content item. A selection may be received using input circuitry 570. Input circuitry 570 may include a keyboard, control panel, or other physical input device connected to user equipment 500 or a data interface such as a USB interface, WiFi receiver, Bluetooth receiver, or infrared receiver. The user selection may be transmitted 572 to transceiver circuitry 506 which in turn transmits 574 the selection to recording service 544. In some embodiments, the input may be transmitted to OTT service 504, which then transmits a request for playback of the recorded content item to recording service 544. Recording service 544 then transmits 576 a request to retrieve and/or stream the recorded content item from cloud DVR storage 552. Recording service 544 receives 578 the requested recorded content from cloud DVR storage 552 and transmits 580 the recorded content item, or streams media data thereof, to user equipment 500. Transceiver circuitry 506 receives the recorded content item and transmits 582 the recorded content item to media processing circuitry 512. In some embodiments, recording service 544 transmits an instruction to user equipment 500 to retrieve the recorded content item from local DVR storage 556. The recorded content item is then transmitted 584 from local DVR storage 556 to media processing circuitry 512. Media processing circuitry 512 then processes the recorded content item for output. For example, media processing circuitry 512 may decode audio and/or video data from the recorded content item and reencode it into a format suitable for output. Media processing circuitry 512 then transmits 586 the media stream to output circuitry 516, which then outputs 588 the recorded content item for consumption by a user.

It should be noted that, while described in the context of user equipment, the processes described above in connection with FIG. 5 may be performed by a server or other remote computing device. For example, OTT service 504 may perform many of the processes in place of user equipment 500.

In some embodiments, a content item is first requested from playback from OTT service 504. During playback of the content item, connection quality between user equipment 500 and OTT service 504 may decrease. For example, there may be a reduction in available bandwidth due to additional users requesting and/or retrieving data and/or content items over the same connection. Alternatively or additionally, a server of OTT service 504 from which the content item is being transmitted to user equipment 500 may become overloaded or may experience transmission issues. Media processing circuitry 512 may monitor the connection quality and request a lower resolution media stream from OTT service 504. Media processing circuitry 512 may also compare the maximum resolution or quality of content that user equipment 500 can currently receive from OTT service 504 with a resolution or quality of a copy of the same content item available from another service, be it cable TV service 528, a different OTT service, or recording service 544. If the maximum resolution or quality of content that user equipment 500 can currently receive from OTT service 504 is lower than the resolution available from another service, user equipment 500 may access or retrieve the content item from the service from which the best quality is available and automatically and seamlessly switch output of the content item from the copy received from OTT service 504 to the best quality copy. For example, media processing circuitry 512 may begin processing media content of the best quality copy at the same playback position as the current playback position in the content item being received from OTT service 504.

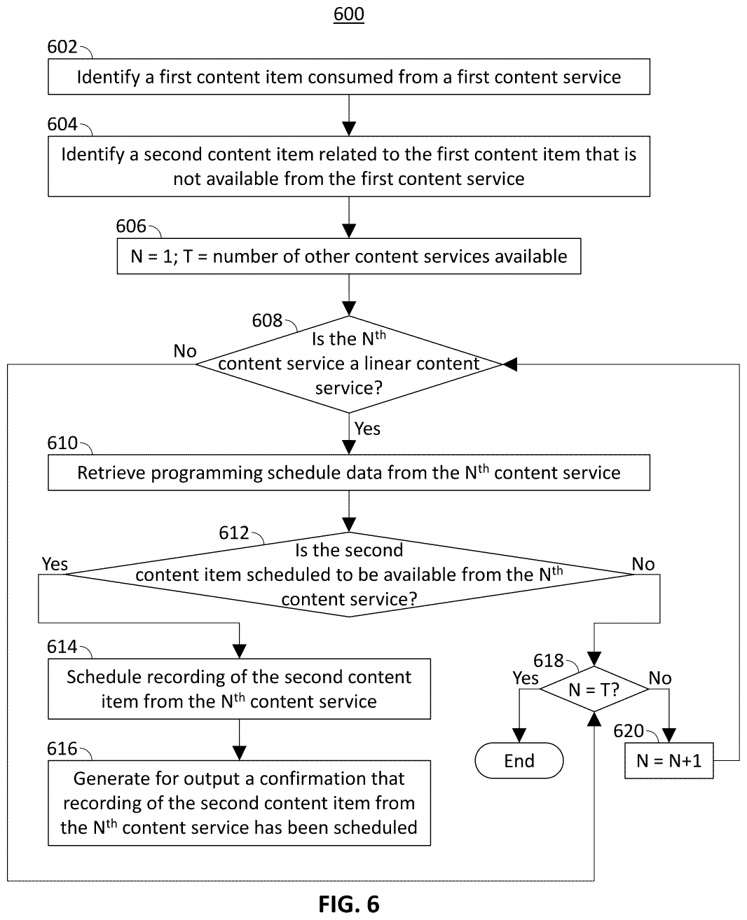

FIG. 6 is a flowchart representing an illustrative process 600 for enabling cross-service content recording, in accordance with some embodiments of the disclosure. Process 600 may be implemented on control circuitry 510. In addition, one or more actions of process 600 may be incorporated into or combined with one or more actions of any other process or embodiment described herein.

At 602, control circuitry 510 identifies a first content item consumed from a first content service. For example, control circuitry 510 may identify a currently playing content item. In some embodiments, control circuitry 510 may identify a selected content item or set of content items, rather than a content item actively being consumed. The content item may be identified using metadata associated with the content item. At 604, control circuitry 510 identifies a second content item related to the first content item that is not available from the first content service. For example, control circuitry 510 may receive a listing of related content items from the first content service and each content item in the listing may has an associated tag indicating its current availability.

At 606, control circuitry 510 initializes a counter variable N, setting its value to one, and a variable T representing the number of other content services available to the user. For example, control circuitry 510 may access a user profile and identify a number of content services to which the user subscribed. These may include OTT services as well as linear (e.g., cable TV) services. At 608, control circuitry 510 determines whether the N^{th} content service is a linear content service. If so (“Yes” at 608), then, at 610, control circuitry 510 retrieves programming schedule data from the N^{th} content service.

At 612, control circuitry 510 determines, based on the programming schedule data, whether the second content item is scheduled to be available from the N^{th} content service. For example, control circuitry 510 may search the programming schedule data for the second content item. If the second content item is scheduled to be available from the N^{th} content service (“Yes” at 612), then, at 614, control circuitry 510 schedules recording of the second content item from the N^{th} content service. For example, control circuitry 510 may transmit an instruction to a recording service or local DVR to set a recording from the content source of the N^{th} content service on which the second content item will be available at a time determined from the programming schedule data. The programming schedule data may include a date and time for the second content item as well as tuning information (e.g., physical channel, program ID, decryption key, etc.) needed to access the second content item. At 616, control circuitry 510 generates for output a confirmation that recording of the second content item from the N^{th} content service has been scheduled. This may be a visual and/or audible output notifying the user that the recording was successfully scheduled. In some embodiments, control circuitry 510, the recording service, or the local DVR may periodically retrieve updated programming schedule data to confirm that the second content item will still be available and may adjust the scheduled recording if any change is detected.

If the second content item is not scheduled to be available from the N^{th} content service (“No” at 612), or if the N^{th} content service is not a linear content service (“No” at 608), then, at 618, control circuitry 510 determines whether N is equal to T, meaning that content from all available content services has been checked. If N is not equal to T (“No” at 618), then, at 620, control circuitry 510 increments the value of N by one and processing returns to 608. If N is equal to T (“Yes” at 618) then the process ends.

The actions and descriptions of FIG. 6 may be used with any other embodiment of this disclosure. In addition, the actions and descriptions described in relation to FIG. 6 may be done in suitable alternative orders or in parallel to further the purposes of this disclosure.

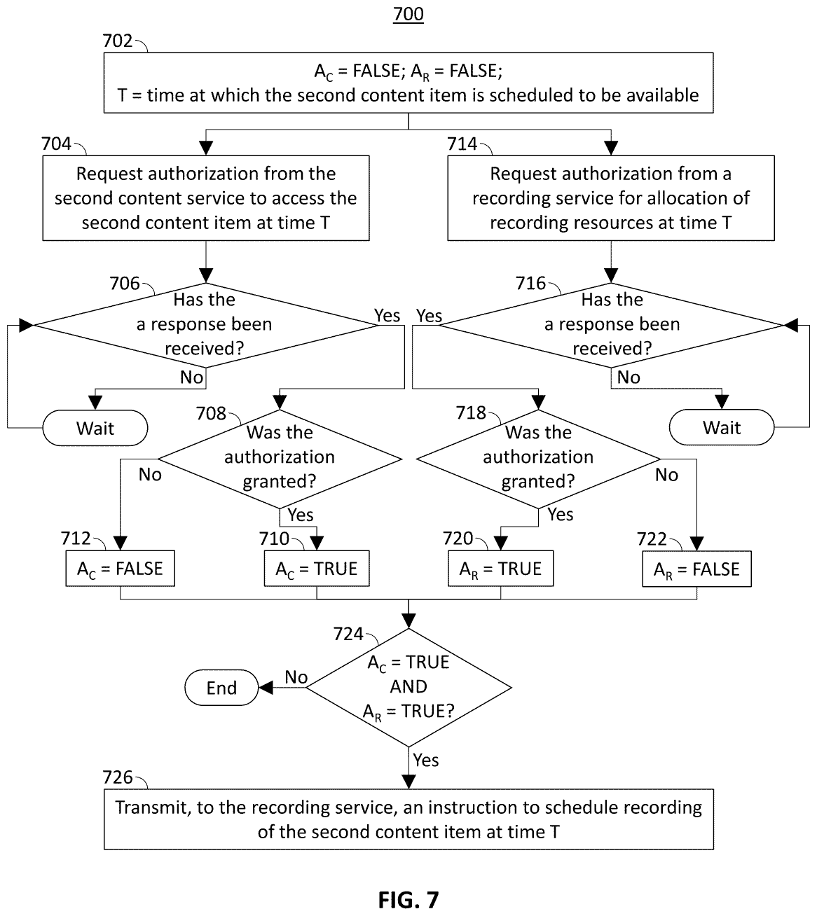

FIG. 7 is a flowchart representing an illustrative process 700 for setting up a recording of a content item scheduled to be available from another content service, in accordance with some embodiments of the disclosure. Process 700 may be implemented on control circuitry 510. In addition, one or more actions of process 700 may be incorporated into or combined with one or more actions of any other process or embodiment described herein.

At 702, control circuitry 510 initializes a flag or Boolean variable A_{C}, setting its value to FALSE, a flag or Boolean value A_{R}, setting its value to FALSE, and a variable T representing a time at which the second content item is scheduled to be available. At 704, control circuitry 510 requests authorization from the second content service to access the second content item at time T. For example, control circuitry 510 may transmit a user account identifier, an identifier of the second content item and a value corresponding to time T to the second content service. At 706, control circuitry 510 determines whether a response to the authorization request has been received. For example, control circuitry 510 may monitor incoming data received at transceiver circuitry 506 to determine if any transmissions have been received from the second content service. If no response has been received (“No” at 706), then control circuitry 510 waits a period of time before returning to 706. If a response has been received (“Yes” at 706), then, at 708, control circuitry 510 determines whether the requested authorization was granted. The second content service may respond to the request for authorization by either approving or denying the request. For example, in response to the request, the second content service may confirm whether the identified user account will have access to the second content item at time T. If so, the second content service may transmit an acknowledgement or approval message indicating that access has been authorized. However, if, for example, a subscription period expires prior to time T, the second content service may deny the request for authorization. Control circuitry 510 processes the response received from the second content service to determine whether the data received indicates an approval or denial of the request. If the request was approved and authorization granted (“Yes” at 708), then, at 710, control circuitry 510 sets the value of A_{C} to TRUE. If, however, the request was denied (“No” at 708), then, at 712, control circuitry 510 sets the value of A_{C} to FALSE.

Similarly, at 714, control circuitry 510 requests authorization from a recording service for allocation of recording resources at time T. For example, control circuitry 510 may transmit a value corresponding to time T, a duration of the second content item, and a resolution of the second content item to the recording service. The recording service may then confirm whether a tuner is available at time T and whether there will be sufficient storage space available to allocate to recording of the second content item based on the resolution and duration of the second content item. At 716, control circuitry 510 determines whether a response to the request for authorization has been received. For example, control circuitry 510 may monitor incoming data received at transceiver circuitry 506 to determine if any transmissions have been received from the recording service. If no response has been received (“No” at 716), then control circuitry 510 waits a period of time before returning to 716. If a response has been received (“Yes” at 716), then, at 718, control circuitry 510 determines whether the requested authorization was granted. The recording service may respond to the request for authorization by either approving or denying the request. For example, in response to the request, the recording service may confirm whether the identified user account will have access to the recording resources at time T, and/or whether sufficient recording resources (e.g., memory space, tuners, streaming media receivers, etc.) will be available at time T. If so, the recording service may transmit an acknowledgement or approval message indicating that access has been authorized. However, if, for example, there will be insufficient memory available to record the content item at time T, the recording service may deny the request for authorization. Control circuitry 510 processes the response received from the recording service to determine whether the data received indicates an approval or denial of the request. If the request was approved and authorization granted (“Yes” at 718), then, at 720, control circuitry 510 sets the value A_{R} to TRUE. If the request was denied (“No” at 718), then, at 722, control circuitry 510 sets the value of A_{R} to FALSE.

At 724, control circuitry 510 determines whether A_{C} and A_{R} are both set to TRUE. If either value is set to FALSE (“No” at 724), then the process ends. In some embodiments, an error message or other indication that one or both services has denied authorization may be generated for output to the user. If both values are set to TRUE (“Yes” at 724), then, at 726, control circuitry 510 transmits, to the recording service, an instruction to schedule recording of the second content item at time T. This may be accomplished as described above in connection with FIG. 6.

The actions and descriptions of FIG. 7 may be used with any other embodiment of this disclosure. In addition, the actions and descriptions described in relation to FIG. 7 may be done in suitable alternative orders or in parallel to further the purposes of this disclosure.

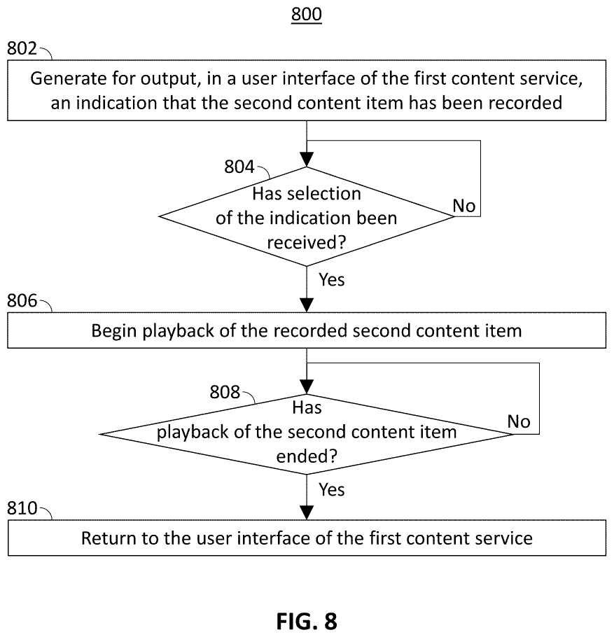

FIG. 8 is a flowchart representing an illustrative process 800 for playing back, from a user interface of a first content service, a content item from a second content service, in accordance with some embodiments of the disclosure. Process 800 may be implemented on control circuitry 510. In addition, one or more actions of process 800 may be incorporated into or combined with one or more actions of any other process or embodiment described herein.

At 802, control circuitry 510 generates for output, in a user interface of the first content service, an indication that the second content item has been recorded. This may be a visual indication such as that depicted in FIG. 3, or any other indicator that informs the user that the content item has been recorded. At 804, control circuitry 510 determines whether a selection of the indication has been received. For example, control circuitry 510 may monitor inputs received from the user and determine whether any input corresponds to a selection of the indication. If selection of the indication has not been received (“No” at 804), control circuitry 510 continues to monitor inputs and determine, at 804, whether selection of the indication has been received.

If selection of the indication has been received (“Yes” at 804), then, at 806, control circuitry 510 begins playback of the recorded second content item. Control circuitry 510 may access the recorded second content item without requiring navigation of a user interface associated with the recording service. At 808, control circuitry 510 determines whether playback of the second content item has ended. This may include completion of playback of the second content item, or receipt of a command or other input to stop playback of the second content item. If playback of the second content item has not ended (“No” at 808), then control circuitry 510 waits, returning periodically to 808 to determine whether playback has ended.

If playback of the second content item has ended (“Yes” at 808), then, at 810, control circuitry 510 returns to the user interface of the first content service. In this way, playback of the recorded content is seamlessly integrated with the user experience of the first content service.

The actions and descriptions of FIG. 8 may be used with any other embodiment of this disclosure. In addition, the actions and descriptions described in relation to FIG. 8 may be done in suitable alternative orders or in parallel to further the purposes of this disclosure.

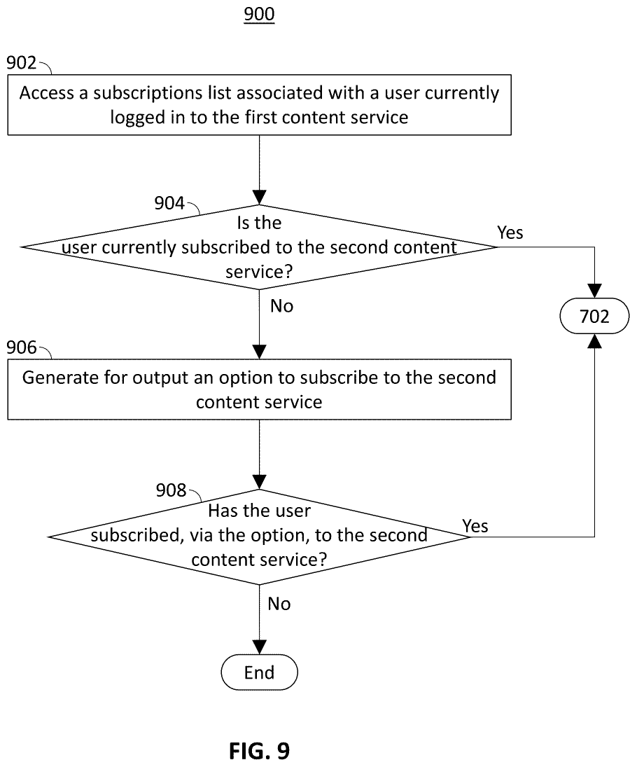

FIG. 9 is a flowchart representing an illustrative process 900 for offering a subscription to a content service on which a content item is or will be available, in accordance with some embodiments of the disclosure. Process 900 may be implemented on control circuitry 510. In addition, one or more actions of process 900 may be incorporated into or combined with one or more actions of any other process or embodiment described herein.

At 902, control circuitry 510 accesses a subscriptions list associated with a user currently logged in to the first content service. For example, control circuitry 510 may access a user profile of the user which includes a list of services to which the user subscribes. At 904, control circuitry 510 determines whether the user is currently subscribed to the second content service. For example, in some embodiments, when identifying content services from which the second content item may be available, all content services available in the user's geographic area may be checked. This may result in one or more contents services to which the user does not currently subscribe being identified as having the second content item available. If the use is currently subscribed (“Yes” at 904), then processing proceeds to 702 of FIG. 7.

However, if the user is not currently subscribed to the second content service (“No” at 904), then, at 906, control circuitry 510 generates for output an option to subscribe to the second content service. For example, control circuitry 510 may generate a prompt for output to the user comprising a selectable option to subscribe to the second content service or to purchase temporary access to the second content service to allow access to the second content item at the time it will be available from the second content service. At 908, control circuitry 510 determines whether the user has subscribed, via the option, to the second content service. For example, control circuitry 510 may monitor user inputs and determine whether an input associated with the prompt has been received that corresponds to selection of the option to subscribe to the second content service. If the user has now subscribed to the second content service (“Yes” at 908), then processing proceeds to 702 of FIG. 7. If the user does not choose to subscribe to the second content service, such as by dismissing the prompt (“No” at 908), then the process ends.

The actions and descriptions of FIG. 9 may be used with any other embodiment of this disclosure. In addition, the actions and descriptions described in relation to FIG. 9 may be done in suitable alternative orders or in parallel to further the purposes of this disclosure.

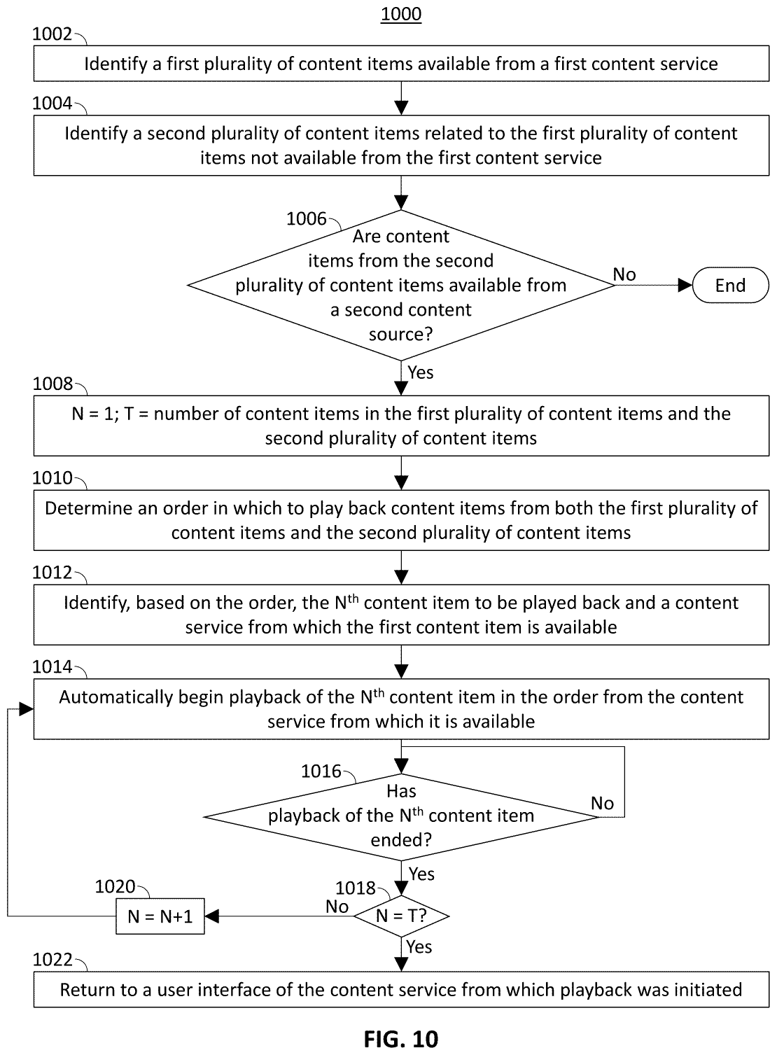

FIG. 10 is a flowchart representing an illustrative process 1000 for seamless playback of content items from different content services, in accordance with some embodiments of the disclosure. Process 1000 may be implemented on control circuitry 510. In addition, one or more actions of process 1000 may be incorporated into or combined with one or more actions of any other process or embodiment described herein.

At 1002, control circuitry 510 identifies a first plurality of content items available from a first content service. For example, control circuitry 510 retrieves a listing of content items from the first content service upon accessing a page or section of a user interface of the first content service. At 1004, control circuitry 510 identifies a second plurality of content items related to the first plurality of content items not available from the first content service. For example, the first plurality of content items may be episodes of a TV show. Some episodes of the TV show may not be available from the first content service, such as a new season of the TV show that is currently airing. Control circuitry 510 may identify the second plurality of content items by retrieving a complete list of content items related to the first plurality of content items and determining which content items from the list are not included in the first plurality of content items.

At 1006, control circuitry 510 determines whether content items from the second plurality of content items are available from a second content source. For example, control circuitry 510 may retrieve content listings from other content services available to the user and search those content listings for content items from the second plurality of content items. If none are available (“No” at 1006), then the process ends. If a content item from the second plurality of content items is available from a second content source (“Yes” at 1006), then, at 1008, control circuitry 510 initializes a counter variable N, setting its value to one, and a variable T representing the number of content items on the first plurality of content items and the second plurality of content items combined.

At 1010, control circuitry 510 determines an order in which to play back content items from both the first plurality of content items and the second plurality of content items. For example, control circuitry 510 may retrieve or otherwise access a complete listing of the related content items, such as an episode listing of a TV show, in sequential order (e.g., by season and episode number, by release date, by timeline order within the series, etc.), Control circuitry 510 may then determine an order of the content items included in both the first and second pluralities of content items by interleaving content items from both the first and second pluralities of content items into a single ordered list of content items.

At 1012, control circuitry 510 identifies, based on the order, an N^{th} content item to be played back and a content service from which the N^{th} content item is available. For example, if N is set to one, control circuitry 510 may select the first content item in the ordered list, which may include not only an identifier of the content item but also an identifier of the content service from which it is available. Alternatively, an identifier of which plurality of content items the selected content item came from may be included in the ordered list. Control circuitry 510 may then determine the content service by identifying the content service associated with the indicated plurality of content items. At 1014, control circuitry 510 automatically begins playback of the N^{th} content item in the order from the content service from which it is available. For example, control circuitry 510 may directly access, e.g., using a deep link, the N^{th} content item and begin playing it back. The N^{th} content item may be accessed from a different content service from a content service for which a user interface is currently being displayed.

At 1016, control circuitry 510 determines whether playback of the N^{th} content item has ended. This may be accomplished using methods described above in connection with FIG. 8. If playback has not ended (“No” at 1016), control circuitry 510 waits a period of time before returning to 1016. If playback of the N^{th} content item has ended (“Yes” at 1016), then, at 1018, control circuitry 510 determines whether N is equal to T, meaning that all content items in both pluralities of content items have been played back according to the order. If N is not equal to T (“No” at 1018), then, at 1020, control circuitry 510 increments the value of N by one, and processing returns to 1014. If N is equal to T (“Yes” at 1018), then, at 1022, control circuitry 510 returns to a user interface of the content service from which playback was initiated.

The actions and descriptions of FIG. 10 may be used with any other embodiment of this disclosure. In addition, the actions and descriptions described in relation to FIG. 10 may be done in suitable alternative orders or in parallel to further the purposes of this disclosure.

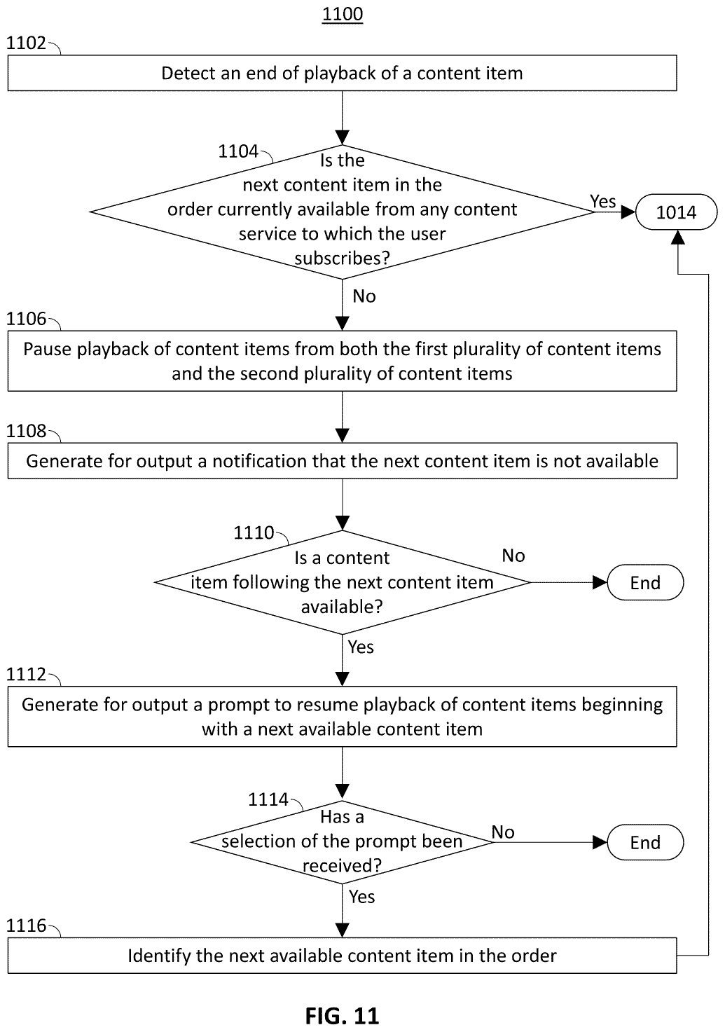

FIG. 11 is a flowchart representing an illustrative process 1100 for playing back a set of content items from different content services, in accordance with some embodiments of the disclosure. Process 1100 may be implemented on control circuitry 510. In addition, one or more actions of process 1100 may be incorporated into or combined with one or more actions of any other process or embodiment described herein.

In some embodiments, the order of content items may be a complete listing of all related content items, regardless of availability of each respective content item in the order. At 1102, control circuitry 510 detects an end of playback of a content item. This may be accomplished using methods described above in connection with FIG. 8. At 1104, control circuitry 510 determines whether the next content item in the order is currently available from any content service to which the user subscribed. If the content its available from a content service to which the user subscribes (“Yes” at 1104), then processing continues at 1014 of FIG. 10. If the next content item is not available from any service to which the user subscribes (“No” at 1104), then, at 1106, control circuitry510 pauses playback of content items from both the first plurality of content items and the second plurality of content items. In other words, no content item is immediately played back after an end of playback of a content item is detected. Instead, at 1108, control circuitry 510 generates for output a notification that the next content item is not available. The user may not wish to proceed with playback of other content items in the order if a next content item is not available. For example, this may result in spoilers for the unavailable content item which the user wants to avoid.

In some cases, the user may not mind if unavailable content items are skipped. At 1110, control circuitry 510 determines whether a content item following the next content item is available. This may be any subsequent content item after the next content item in the order. If not (“No” at 1110), then the process ends. If a content item following the next content item is available (“Yes” at 1110), then, at 1112, control circuitry 510 generates of output a prompt to resume playback of content items beginning with the next available content item.

At 1114, control circuitry 510 determines whether a selection of the prompt has been received. If not (“No” at 1114), then the process ends, and no further content items are played back. Control circuitry 510 may return to a user interface of the content service from which playback was initiated. If, however, the user has selected the prompt to proceed with playback of available content items despite the unavailability of one or more content items in the order (“Yes” at 1114), then, at 1116, control circuitry 510 identifies a next available content item in the order and processing proceed to 1014 of FIG. 10.

The actions and descriptions of FIG. 11 may be used with any other embodiment of this disclosure. In addition, the actions and descriptions described in relation to FIG. 11 may be done in suitable alternative orders or in parallel to further the purposes of this disclosure.

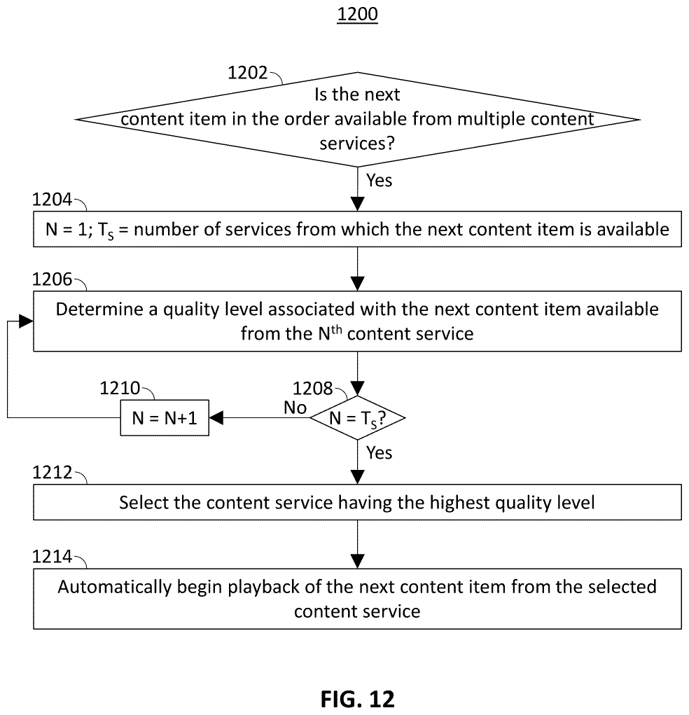

FIG. 12 is a flowchart representing an illustrative process 1200 for selecting a content service from which to play back a next content item, in accordance with some embodiments of the disclosure. Process 1200 may be implemented on control circuitry 510. In addition, one or more actions of process 1200 may be incorporated into or combined with one or more actions of any other process or embodiment described herein.

At 1202, control circuitry 510 determines whether the next content item in the order is available from multiple content services. For example, control circuitry 510 may access or retrieve a content catalog from each available content service and search each catalog for the next content item. If the next content item is available from more than one content service (“Yes” at 1202), then, at 1204, control circuitry 510 initializes a counter variable N, setting its value to one, and a variable T_{S} representing the number of content services from which the next content item is available. At 1206, control circuitry 510 determines a quality level associated with the next content item available from the N^{th} content service. For example, control circuitry 510 may determine a video or audio resolution of a copy of the next content item available from the N^{th} content service. Control circuitry 510 may also determine network conditions between a user equipment device being used for playback and a server of the N^{th} content service. For example, control circuitry 510 may ping the server and determine a response time. Control circuitry 510 may also request network traffic data from a local router, and/or request network load data from the server. Based on one or more of these data, control circuitry 510 may determine a quality level associated with the content item available from the N^{th} content service.

At 1208, control circuitry 510 determines whether N is equal to T_{S}, meaning that the quality level associated with the content item available from all content services has been determined. If N is not equal to T_{S} (“No” at 1208), then, at 1210, control circuitry 510 increments the value of N by one, and processing returns to 1206. If N is equal to T_{S} (“Yes” at 1208), then, at 1212, control circuitry 510 selects the content service having the highest quality level associated with its copy of the next content item. At 1214, control circuitry 510 automatically begins playback of the next content item from the selected content service.

The actions and descriptions of FIG. 12 may be used with any other embodiment of this disclosure. In addition, the actions and descriptions described in relation to FIG. 12 may be done in suitable alternative orders or in parallel to further the purposes of this disclosure.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, some in different orders, or done in parallel. In addition, the systems and methods described herein may be performed in real time. It should be noted that the systems and/or methods described above may be applied to, or used in accordance with, other systems and/or methods.

1. A method for seamless playback of content items from different content services, the method comprising:
identifying a first plurality of content items available from a first content service;
identifying a second plurality of content items not available from the first content service, wherein each content item of the second plurality of content items is related to the first plurality of content items;
determining whether content items of the second plurality of content items are available from a second content service; and
in response to determining that content items of the second plurality of content items are available from the second content service:
determining an order in which to play back content items from both the first plurality of content items and the second plurality of content items;
playing back a first content item from the first plurality of content items;
detecting an end of playback of the first content item from the first plurality of content items;
identifying, based on the order, that a second content item from the second plurality of content items is to be played back next; and
automatically beginning playback of the second content item of the second plurality of content items from the second content service.

2. The method of claim 1, further comprising:
detecting an end of playback of the second content item from the second plurality of content items;
identifying, based on the order, that a third content item from the first plurality of content items is to be played back next; and
automatically beginning playback of the third content item of the first plurality of content items from the first content service.

3. The method of claim 1, wherein playback of content items is initiated from a user interface of the first content service, the method further comprising:
detecting an end of playback of the second content item from the second plurality of content items;
determining that the second content item is last in the order; and
returning to the user interface of the first content service.

4. The method of claim 1, wherein the order in which to play back content items includes content items not currently available from any content service, the method further comprising:
detecting an end of playback of the second content item from the second plurality of content items;
identifying, based on the order, a next content item to be played back;
determining whether the next content item is included in either the first plurality of content items or the second plurality of content items; and
in response to determining that the next content item is not included in either the first plurality of content items or the second plurality of content items:
pausing playback of content items from both the first plurality of content items and the second plurality of content items; and
generating for output a notification that the next content item is not available.

5. The method of claim 4, further comprising:
determining whether a content item following the next content item in the order is included in either the first plurality of content items or the second plurality of content items; and
in response to determining that the content item following the next content item in the order is included in either the first plurality of content items or the second plurality of content items, generating for output a prompt to resume playback of content items beginning with a next available content item in the order.

6. The method of claim 5, further comprising:
receiving selection of the prompt; and
in response to receiving selection of the prompt:
identifying the next available content item in the order;
determining a content service from which the next available content item is available; and
automatically beginning playback of the next available content item from the determined content service.

7. The method of claim 4, further comprising:
determining whether the next content item is available from any content service; and
in response to determining that the next content item is available from a third content service, generating for output an option to subscribe to the third content service.

8. The method of claim 1, further comprising:
determining that the second content item is available from both the first content service and the second content service;
determining a respective quality level associated with the second content item available from the first content service and the second content item available from the second content service;
selecting a content service having a higher respective quality level; and
automatically beginning playback of the second content item from the selected content service.

9. The method of claim 8, wherein the respective quality level is determined based on network conditions between a playback device and a server of a respective content service.

10. The method of claim 8, wherein the respective quality level is determined based on media characteristics of the second content item available from a respective content service.

11. The method of claim 1, wherein the first content service is an on-demand content service and the second content service is one of a linear content service or a recording service.

12. A system for seamless playback of content items from different content services, the system comprising:
output circuitry; and
control circuitry configured to:
identify a first plurality of content items available from a first content service;
identify a second plurality of content items not available from the first content service, wherein each content item of the second plurality of content items is related to the first plurality of content items;
determine whether content items of the second plurality of content items are available from a second content service; and
in response to determining that content items of the second plurality of content items are available from the second content service:
determine an order in which to play back content items from both the first plurality of content items and the second plurality of content items;
play back, using the output circuitry, a first content item from the first plurality of content items;
detect an end of playback of the first content item from the first plurality of content items;
identify, based on the order, that a second content item from the second plurality of content items is to be played back next; and
automatically begin playback, using the output circuitry, of the second content item of the second plurality of content items from the second content service.

13. The system of claim 12, wherein the control circuitry is further configured to:
detect an end of playback of the second content item from the second plurality of content items;
identify, based on the order, that a third content item from the first plurality of content items is to be played back next; and
automatically begin playback, using the output circuitry, of the third content item of the first plurality of content items from the first content service.

14. The system of claim 12, wherein playback of content items is initiated from a user interface of the first content service, and wherein the control circuitry is further configured to:
detect an end of playback of the second content item from the second plurality of content items;
determine that the second content item is last in the order; and
return to the user interface of the first content service.

15. The system of claim 12, wherein the order in which to play back content items includes content items not currently available from any content service, and wherein the control circuitry is further configured to:
detect an end of playback of the second content item from the second plurality of content items;
identify, based on the order, a next content item to be played back;
determine whether the next content item is included in either the first plurality of content items or the second plurality of content items; and
in response to determining that the next content item is not included in either the first plurality of content items or the second plurality of content items:
pause playback of content items from both the first plurality of content items and the second plurality of content items; and
generate for output a notification that the next content item is not available.

16. The system of claim 15, wherein the control circuitry is further configured to:
determine whether a content item following the next content item in the order is included in either the first plurality of content items or the second plurality of content items; and
in response to determining that the content item following the next content item in the order is included in either the first plurality of content items or the second plurality of content items, generate for output a prompt to resume playback of content items beginning with a next available content item in the order.

17. The system of claim 16, wherein the control circuitry is further configured to:
receive selection of the prompt; and
in response to receiving selection of the prompt:
identify the next available content item in the order;
determine a content service from which the next available content item is available; and
automatically begin playback, suing the output circuitry, of the next available content item from the determined content service.

18. The system of claim 15, wherein the control circuitry is further configured to:
determine whether the next content item is available from any content service; and
in response to determining that the next content item is available from a third content service, generate for output an option to subscribe to the third content service.

19. The system of claim 12, wherein the control circuitry is further configured to:
determine that the second content item is available from both the first content service and the second content service;
determine a respective quality level associated with the second content item available from the first content service and the second content item available from the second content service;
select a content service having a higher respective quality level; and
automatically begin playback, using the output circuitry, of the second content item from the selected content service.

20. The system of claim 19, wherein the respective quality level is determined based on network conditions between a playback device and a server of a respective content service.

21. The system of claim 19, wherein the respective quality level is determined based on media characteristics of the second content item available from a respective content service.

22. The system of claim 12, wherein the first content service is an on-demand content service and the second content service is one of a linear content service or a recording service

23.-55. (canceled)
